(19) United States
(12) Patent Application Publication
(10) Pub. No.: US 2025/0330975 A1
(43) Pub. Date: Oct. 23, 2025

(54) UPLINK COLLISION HANDLING FOR MULTIPLE TRANSMISSION-RECEPTION COMMUNICATIONS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/870,947

(22) PCT Filed: Jul. 14, 2022
(86) PCT No.: PCT/CN2022/105685

§ 371 Date: Dec. 2, 2024

(51) Int. Cl. H04W 72/1268; H04L 5/00; H04W 72/0446; H04W 72/115

(52) U.S. Cl. CPC H04W 72/1268; H04L 5/0098; H04W 72/0446; H04W 72/115

(57) ABSTRACT

Systems, devices, and methods for handling uplink (UL) collisions in multi-transmission reception point (mTRP) communication scenarios are provided. A wireless communication method may be performed based on a mTRP UL prioritization configuration. For example, a method of wireless communication performed by a user equipment (UE) may include: receiving a first indication scheduling a first uplink (UL) communication associated with a first transmission configuration indicator (TCI) state and a first TRP; receiving a second indication scheduling a second UL communication associated with a second TCI state and a second TRP, wherein the second UL communication is scheduled to at least partially overlap in time with the first UL communication, and wherein the first UL communication and the second UL communication are scheduled for at least one of a same component carrier (CC) or a same frequency band; and transmitting, based on a mTRP UL prioritization configuration, the first UL communication.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5th Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

It may be desirable or advantageous to align uplink (UL) communications at a BS based on a BS timing configuration. For example, in orthogonal multiple access in which different UEs may communicate in consecutive time resources (e.g., slots), and/or where different UEs may be configured to communicate with the BS simultaneously but in different frequency resources (e.g., carriers, subcarriers), proper timing alignment of the UEs with the BS may reduce or avoid intra-cell interference. The UEs may compensate for the delay (e.g., propagation delay) of UL communications transmitted to the BS by determining and applying a timing advance to the UL communications.

In a multi-transmission-reception point (mTRP) communication scenario, a UE may be scheduled to communicate with one or more transmission reception points (TRPs). In some aspects, the TRPs may be at different physical locations. In other aspects, the TRPs may be co-located. Although the TRPs may not be in the same location, the communications transmitted by the TRPs may be transmitted in a same logical cell, including the same frequency resources, for example. In single-downlink control information (DCI) mTRP communications, a DCI from one of the TRPs may schedule communications for each of a plurality of TRPs. In multi-DCI (mDCI) mTRP (mTRP) communications, each TRP may transmit DCI to the UE to schedule communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some instances, a user equipment (UE) in a multi-transmission reception point (mTRP) communication scenario may be indicated, configured, and/or otherwise scheduled to transmit two uplink (UL) communications at a same time. In some instances, the UE may not be capable of simultaneously transmitting the two UL communications. For example, in some aspects, the two UL communications may be associated with or configured with TCI states that are not capable of simultaneous transmission. In other aspects, the two UL communications may be associated with or configured with a same TCI state and the UL communications may not be transmitted simultaneously. This scenario may be referred to as a scheduling collision, or collision. The present disclosure describes methods, mechanisms, and systems for handling UL collisions in mTRP communication scenarios. In some aspects, the methods and mechanisms described herein may be performed based on a mTRP UL prioritization configuration. In some aspects, the mTRP UL prioritization configuration may indicate or configure priorities of colliding UL communications based on a UL channel type, associated TCI state, receiving TRP, timing, and/or indication or scheduling mechanism.

According to an aspect of the present disclosure, a method of wireless communication performed by a user equipment (UE) comprises: receiving a first indication scheduling a first uplink (UL) communication associated with a first transmission configuration indicator (TCI) state and a first transmission reception point (TRP); receiving a second indication scheduling a second UL communication associated with a second TCI state and a second TRP, wherein the second UL communication is scheduled to at least partially overlap in time with the first UL communication, and wherein the first UL communication and the second UL communication are scheduled for at least one of a same component carrier (CC) or a same frequency band; and transmitting, based on a multi-TRP (mTRP) UL prioritization configuration, the first UL communication.

According to an aspect of the present disclosure, a UE comprises: a memory device; a transceiver; and a processor in communication with the memory device and the transceiver, wherein the UE is configured to: receive a first indication scheduling a first uplink (UL) communication associated with a first transmission configuration indicator (TCI) state and a first transmission reception point (TRP); receive a second indication scheduling a second UL communication associated with a second TCI state and a second TRP, wherein the second UL communication is scheduled to at least partially overlap in time with the first UL communication, and wherein the first UL communication and the second UL communication are scheduled for at least one of a same component carrier (CC) or a same frequency band; and transmit, based on a multi-TRP (mTRP) UL prioritization configuration, the first UL communication.

According to an aspect of the present disclosure a non-transitory, computer-readable medium comprises program code recorded thereon, wherein the program code comprises instructions executable by a processor of a user equipment (UE) to cause the UE to: receive a first indication scheduling a first uplink (UL) communication associated with a first transmission configuration indicator (TCI) state and a first transmission reception point (TRP); receive a second indication scheduling a second UL communication associated with a second TCI state and a second TRP, wherein the second UL communication is scheduled to at least partially overlap in time with the first UL communication, and wherein the first UL communication and the second UL communication are scheduled for at least one of a same component carrier (CC) or a same frequency band; and transmit, based on a multi-TRP (mTRP) UL prioritization configuration, the first UL communication.

According to an aspect of the present disclosure a UE comprises: means for receiving a first indication scheduling a first uplink (UL) communication associated with a first transmission configuration indicator (TCI) state and a first transmission reception point (TRP); means for receiving a second indication scheduling a second UL communication associated with a second TCI state and a second TRP, wherein the second UL communication is scheduled to at least partially overlap in time with the first UL communication, and wherein the first UL communication and the second UL communication are scheduled for at least one of a same component carrier (CC) or a same frequency band; and means for transmitting, based on a multi-TRP (mTRP) UL prioritization configuration, the first UL communication.

Other aspects, features, and embodiments will become apparent to those of ordinary skill in the art, upon reviewing the following description of specific, exemplary aspects in conjunction with the accompanying figures. While features may be discussed relative to certain aspects and figures below, all aspects can include one or more of the advantageous features discussed herein. In other words, while one or more aspects may be discussed as having certain advantageous features, one or more of such features may also be used in accordance with the various aspects discussed herein. In similar fashion, while exemplary aspects may be discussed below as device, system, or method aspects it should be understood that such exemplary aspects can be implemented in various devices, systems, and methods.

### BRIEF DESCRIPTION OF THE DRAWINGS

FIG. 1A illustrates a wireless communication network according to some aspects of the present disclosure.

FIG. 1B is a diagram illustrating an example disaggregated BS architecture according to some aspects of the present disclosure.

FIG. 2 illustrates a communication scenario with a reconfigurable intelligent surface according to some aspects of the present disclosure.

FIG. 3 is a diagram illustrating an uplink (UL) scheduling collision in a multiple transmission-reception point (mTRP) communication scenario, according to aspects of the present disclosure.

FIG. 4 illustrates a transmission frame for a communication network according to some embodiments of the present disclosure.

FIG. 5 is a signaling diagram of a multiple transmission-reception point (mTRP) communication method according to some aspects of the present disclosure.

FIG. 6 illustrates a block diagram of a base station (BS) according to some aspects of the present disclosure.

FIG. 7 illustrates a block diagram of a user equipment (UE) according to some aspects of the present disclosure.

FIG. 8 is a flow diagram of a wireless communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some aspects, well-known structures and components are shown in block diagram form in order to avoid obscuring such concepts.

This disclosure relates generally to wireless communications systems, also referred to as wireless communications networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an Ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 ms), and users with wide ranges of mobility or lack thereof; and (3) with enhanced mobile broadband including extreme high capacity (e.g., ˜ 10 Tbps/km²), extreme data rates (e.g., multi-Gbps rate, 100+ Mbps user experienced rates), and deep awareness with advanced discovery and optimizations.

A 5G NR communication system may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW. In certain aspects, frequency bands for 5G NR are separated into multiple different frequency ranges, a frequency range one (FR1), a frequency range two (FR2), and FR2x. FR1 bands include frequency bands at 7 GHz or lower (e.g., between about 410 MHz to about 7125 MHz). FR2 bands include frequency bands in mmWave ranges between about 24.25 GHz and about 52.6 GHz. FR2x bands include frequency bands in mmWave ranges between about 52.6 GHz to about 71 GHz. The mmWave bands may have a shorter range, but a higher bandwidth than the FR1 bands. Additionally, 5G NR may support different sets of subcarrier spacing for different frequency ranges.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

In a multi-transmission-reception point (mTRP) communication scenario, a UE may be scheduled to communicate with one or more transmission reception points (TRPs). In some aspects, the TRPs may be at different physical locations. In other aspects, the TRPs may be co-located. Although the TRPs may not be in the same location, the communications transmitted by the TRPs may be transmitted in a same logical cell, including the same frequency resources, for example. In single-DCI mTRP communications, a DCI from one of the TRPs may schedule communications for each of a plurality of TRPs. In multi-DCI (mDCI) mTRP (mTRP) communications, each TRP may transmit DCI to the UE to schedule communications.

In some aspects, one or more of the serving cells may be configured for mDCI mTRP communications and one or more cells may be configured for single-DCI mTRP communications or single TRP communications. A cell may be configured for mDCI mTRP communications if the cell configuration indicates two control resource set (CORESET) pool index values and two timing advance groups (TAGs). For example, a mDCI mTRP cell may be configured with two CORESET pool index values and two TAG indicators. A single-DCI mTRP cell or single-TRP cell configuration may indicate a single TAG indicator and/or a single CORESET pool index value. When a cell is configured for mDCI mTRP communications, UL signals on the cell may be transmitted to one of multiple TRPs.

In mTRP communications, simultaneous DL and/or UL communications associated with different TRPs may be multiplexed by time domain multiplexing (TDM), frequency domain multiplexing (FDM), and/or spatial domain multiplexing (SDM). In spatial domain multiplexing, for example, a UE may use the same frequency and time resources to transmit and/or receive mTRP communications using distinct spatial filters for each communication. In some aspects, a spatial filter may refer to a scheme or configuration enabled for an array of antenna elements to adjust the phase of signals from each antenna element to create a focused beam oriented along a plane or axis. The process of phase shifting to create the focused beam may be referred to as beam forming. In some aspects, the UE may use two different spatial filters to transmit and/or receive communications simultaneously to different TRPs. In some aspects, the UE may use different antenna panels or antenna arrays to perform the simultaneous transmissions.

In some aspects, the spatial filtering may be transparent to the receiving device such that the receiving device need not know the spatial configuration of the received beam to process and decode the received signal. In other aspects, the transmitting device may indicate the beam configuration to the receiving device for processing, filtering, etc. A beam indication may inform the receiving device that, for example, a physical uplink shared channel (PUSCH) communication is transmitted using the same spatial filter as the corresponding UL reference signal transmitted therewith (e.g., DMRS). In some aspects, the transmitting device may indicate the beam parameters or characteristics with one or more transmission configuration indicator (TCI) states. A TCI state may indicate information about a reference signal and/or the spatial characteristics of a beam. A wireless communication device may be configured with several candidate TCI states. In some aspects, a subset of the candidate TCI states may be activated or assigned for different DL and/or UL resources. TCI states, as well as other beam parameters, may be dynamically indicated between a UE and a TRP, for example. In some aspects, the network, via a TRP, may indicate a TCI state for a DL communication in DCI. Similarly, the network may indicate a TCI state to be used for a scheduled UL communication in the scheduling DCI, for example.

As mentioned above, mTRP communications may be scheduled by sDCI or by mDCI. In sDCI, a single DCI from a single TRP may be used to schedule DL and/or UL communications from multiple TRPs. Accordingly, in some aspects, the sDCI may include or indicate more than one TCI state. In some instances, a UE in a mTRP communication scenario may be indicated, configured, and/or otherwise scheduled to transmit two UL communications at a same time. In some instances, the UE may not be configured to or capable of simultaneously transmitting the two UL communications at the same time. For example, in some aspects, the two UL communications may be associated with or configured with TCI states that are not capable of simultaneous transmission. In other aspects, the two UL communications may be associated with or configured with a same TCI state and the UL communications may not be transmitted simultaneously. This scenario may be referred to as a scheduling collision, or collision. In some instances, the collision may cause or result in an error case in which neither communication is transmitted. This may decrease the efficiency of network resource usage, increasing latency, and higher power usage at the UE.

The present disclosure describes methods, mechanisms, and systems for handling UL collisions in mTRP scenarios. In some aspects, the methods and mechanisms described herein may be performed based on a mTRP prioritization configuration. In some aspects, the mTRP prioritization configuration may be configured at the network and/or at the UE. For example, the UE may be preconfigured with a hard coded set of rules to determine a priority of colliding UL communications in a mTRP scenario. The mTRP prioritization configuration may indicate or configure priorities of colliding UL communications based on a UL channel type (e.g., PUSCH, SRS, PRACH, etc.), associated TCI state, receiving TRP, timing, and/or indication or scheduling mechanism (e.g., DCI-scheduled, RRC-configured, etc.).

The schemes and mechanisms of the present disclosure advantageously facilitate multi-panel simultaneous transmission of UL mTRP communications. Accordingly, the throughput and/or reliability of UL communications may be increased. Further, the unified TCI indication schemes described herein may reduce network overhead so that a single DCI may indicate multiple TCI states and so that the TCI states are mapped to other beam parameters for the UL communications.

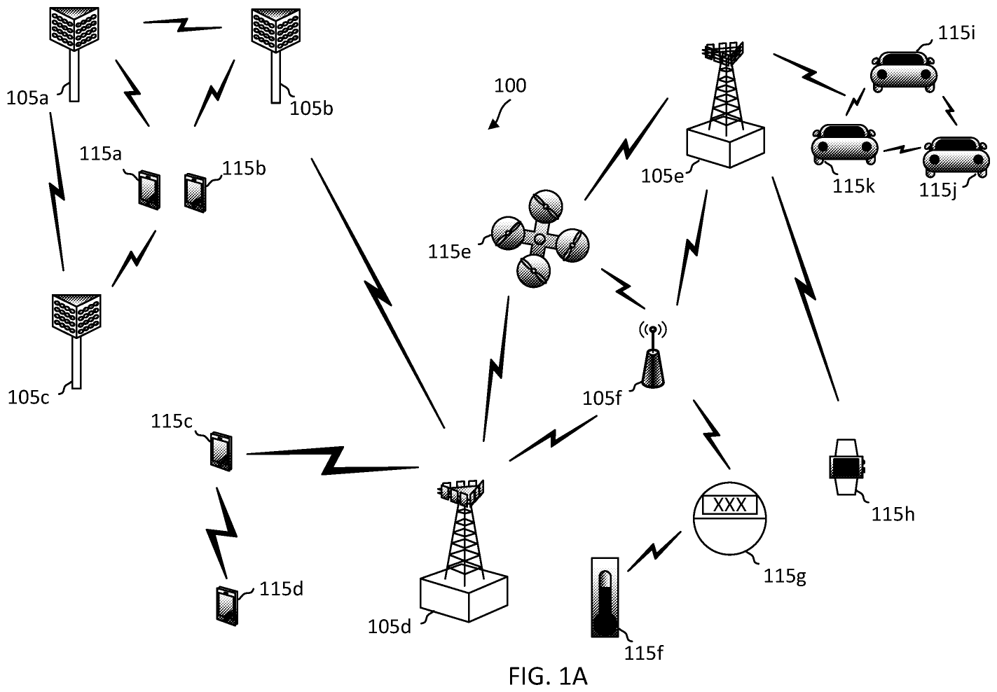

FIG. 1A illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 (individually labeled as 115a, 115b, 115c, 115d, 115e, 115f, 115g, 115h, and 115k) and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1A, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1A, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (COMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-action-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such asV2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some aspects, the subcarrier spacing between adjacent subcarriers may be fixed, and the total number of subcarriers (K) may be dependent on the system BW. The system BW may also be partitioned into subbands. In other aspects, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes an UL subframe in an UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate an UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. an UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some aspects, the BSs 105 may broadcast the PSS, the SSS, and/or the MIB in the form of synchronization signal block (SSBs) and may broadcast the RMSI and/or the OSI over a physical downlink shared channel (PDSCH). The MIB may be transmitted over a physical broadcast channel (PBCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, an UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit an UL communication signal to the BS 105 via a PUSCH and/or PUCCH according to an UL scheduling grant. The connection may be referred to as an RRC connection. When the UE 115 is actively exchanging data with the BS 105, the UE 115 is in an RRC connected state.

In an example, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), and/or a packet data network gateway (PGW), to complete the network attachment procedure. For example, the BS 105 may coordinate with the network entities in the 5GC to identify the UE, authenticate the UE, and/or authorize the UE for sending and/or receiving data in the network 100. In addition, the AMF may assign the UE with a group of tracking areas (TAs). Once the network attach procedure succeeds, a context is established for the UE 115 in the AMF. After a successful attach to the network, the UE 115 can move around the current TA. For tracking area update (TAU), the BS 105 may request the UE 115 to update the network 100 with the UE 115's location periodically. Alternatively, the UE 115 may only report the UE 115's location to the network 100 when entering a new TA. The TAU allows the network 100 to quickly locate the UE 115 and page the UE 115 upon receiving an incoming data packet or call for the UE 115.

In some aspects, the BS 105 may communicate with a UE 115 using hybrid automatic repeat request (HARQ) techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands and/or unlicensed frequency bands. For example, the network 100 may be an NR-U network operating over an unlicensed frequency band. In such an aspect, the BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. A TXOP may also be referred to as COT. The goal of LBT is to protect reception at a receiver from interference. For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel.

An LBT can be based on energy detection (ED) or signal detection. For an energy detection-based LBT, the LBT results in a pass when signal energy measured from the channel is below a threshold. Conversely, the LBT results in a failure when signal energy measured from the channel exceeds the threshold. For a signal detection-based LBT, the LBT results in a pass when a channel reservation signal (e.g., a predetermined preamble signal) is not detected in the channel. Additionally, an LBT may be in a variety of modes. An LBT mode may be, for example, a category 4 (CAT4) LBT, a category 2 (CAT2) LBT, or a category 1 (CAT1) LBT. A CAT1 LBT is referred to a no LBT mode, where no LBT is to be performed prior to a transmission. A CAT2 LBT refers to an LBT without a random backoff period. For instance, a transmitting node may determine a channel measurement in a time interval and determine whether the channel is available or not based on a comparison of the channel measurement against a ED threshold. A CAT4 LBT refers to an LBT with a random backoff and a variable contention window (CW). For instance, a transmitting node may draw a random number and backoff for a duration based on the drawn random number in a certain time unit.

FIG. 1B shows a diagram illustrating an example disaggregated base station 102 architecture. The disaggregated base station 102 architecture may include one or more central units (CUs) 150 that can communicate directly with a core network 104 via a backhaul link, or indirectly with the core network 104 through one or more disaggregated base station units (such as a Near-Real Time (Near-RT) RAN Intelligent Controller (RIC) 125 via an E2 link, or a Non-Real Time (Non-RT) RIC 145 associated with a Service Management and Orchestration (SMO) Framework 135, or both). A CU 150 may communicate with one or more distributed units (DUs) 130 via respective midhaul links, such as an F1 interface. The DUs 130 may communicate with one or more radio units (RUs) 140 via respective fronthaul links. The RUs 140 may communicate with respective UEs 120 via one or more radio frequency (RF) access links. In some implementations, the UE 120 may be simultaneously served by multiple RUs 140.

Each of the units, i.e., the CUS 150, the DUs 130, the RUs 140, as well as the Near-RT RICs 125, the Non-RT RICs 145 and the SMO Framework 135, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 150 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 150. The CU 150 may be configured to handle user plane functionality (i.e., Central Unit-User Plane (CU-UP)), control plane functionality (i.e., Central Unit-Control Plane (CU-CP)), or a combination thereof. In some implementations, the CU 150 can be logically split into one or more CU-UP units and one or more CU-CP units. The CU-UP unit can communicate bidirectionally with the CU-CP unit via an interface, such as the E1 interface when implemented in an O-RAN configuration. The CU 150 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 130 may further host one or more low PHY layers. Each layer (or module) can be implemented with an interface configured to communicate signals with other layers (and modules) hosted by the DU 130, or with the control functions hosted by the CU 150.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs. In some implementations, real-time and non-real-time aspects of control and user plane communication with the RU(s) 140 can be controlled by the corresponding DU 130. In some scenarios, this configuration can enable the DU(s) 130 and the CU 150 to be implemented in a cloud-based RAN architecture, such as a vRAN architecture.

The SMO Framework 135 may be configured to support RAN deployment and provisioning of non-virtualized and virtualized network elements. For non-virtualized network elements, the SMO Framework 135 may be configured to support the deployment of dedicated physical resources for RAN coverage requirements which may be managed via an operations and maintenance interface (such as an O1 interface). For virtualized network elements, the SMO Framework 135 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 150, DUs 130, RUs 140 and Near-RT RICs 125. In some implementations, the SMO Framework 135 can communicate with a hardware aspect of a 4G RAN, such as an open eNB (O-eNB) 111, via an O1 interface. Additionally, in some implementations, the SMO Framework 135 can communicate directly with one or more RUs 140 via an O1 interface. The SMO Framework 135 also may include a Non-RT RIC 145 configured to support functionality of the SMO Framework 135.

The Non-RT RIC 145 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 145 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 150, one or more DUs 130, or both, as well as an O-eNB, with the Near-RT RIC 125.

In some implementations, to generate AI/ML models to be deployed in the Near-RT RIC 125, the Non-RT RIC 145 may receive parameters or external enrichment information from external servers. Such information may be utilized by the Near-RT RIC 125 and may be received at the SMO Framework 135 or the Non-RT RIC 145 from non-network data sources or from network functions. In some examples, the Non-RT RIC 145 or the Near-RT RIC 125 may be configured to tune RAN behavior or performance. For example, the Non-RT RIC 145 may monitor long-term trends and patterns for performance and employ AI/ML models to perform corrective actions through the SMO Framework 135 (such as reconfiguration via O1) or via creation of RAN management policies (such as A1 policies).

Referring again to FIG. 1A, in some aspects, one or more of the UEs 115 may be configured to communicate with two or more of the BSs 105 in a multi-transmission-reception point (mTRP) communication scenario. For example, a UE 115 may be configured with a first frequency band or cell, where the cell is configured for communications on more than one TRP. The UE 115 may receive DL communications (e.g., DCI, PDSCH, DL reference signals) from each TRP. The UE 115 may also transmit UL communications to one or more of the TRPs.

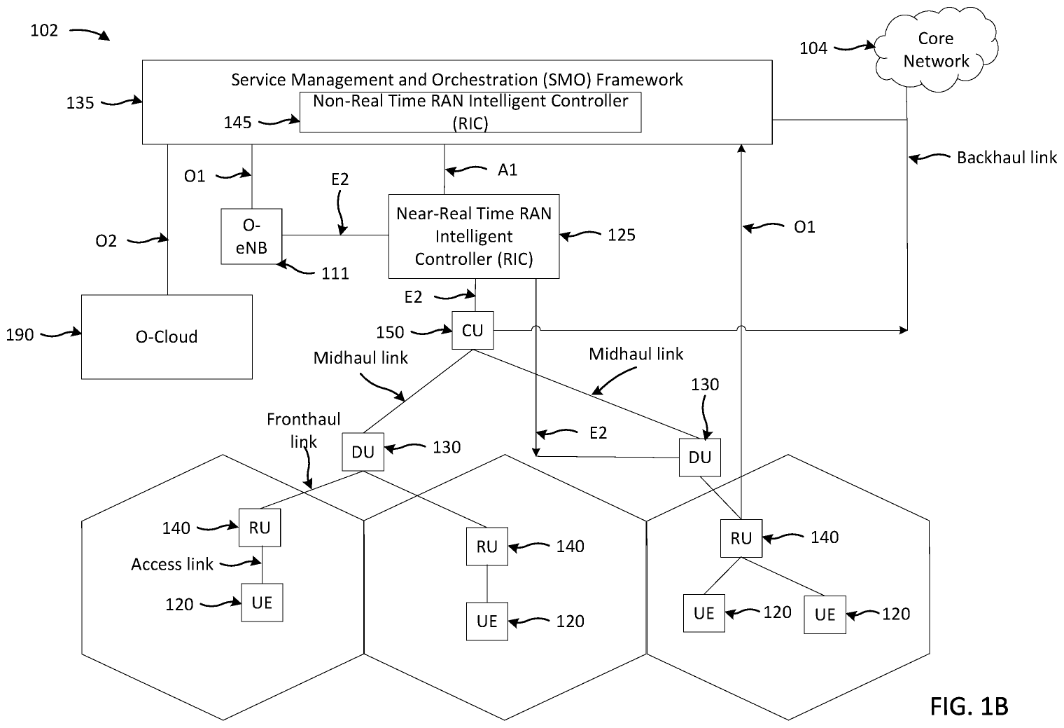

FIG. 2 illustrates a multiple transmission-reception point (mTRP) communication scenario 200 according to aspects of the present disclosure. The communication scenario 200 involves a first TRP 205a, a second TRP 205b, and a UE 215. In some aspects, one or both of the TRPs 205 may be one or more of the BSs 105 of the network 100. In other aspects, one or both of the TRPs 205 may be another type of wireless node or wireless communication device configured for communication with one or more UEs in a network. In some aspects, the UE 215 may be one of the UEs 115 of the network 100. For simplicity, FIG. 2 illustrates one UE 215 and two TRPs 205, but a greater number of UEs 215 (e.g., about 2, 3, 4, 5, 6, 7, 8, 9, 10, or more) and/or TRPs 205 (e.g., the about 2, 3, 4 or more) may be supported. In the scenario 200, the TRPs 205 and the UE 215 communicate with each other over at least one radio frequency band. For example, the TRPs 205 may be configured to communicate with the UE 215 on one or more cells corresponding to one or more frequency bands. In some aspects, each of the one or more cells corresponds to a component carrier (CC). In other aspects, each of the one or more cells corresponds to a bandwidth part (BWP). The one or more cells may include a primary cell (PCell) or special cell (SpCell).

In some aspects, one or both of the TRPs 205 may be capable of generating a number of directional transmission beams in a number of beam or spatial directions (e.g., about 2, 4, 8, 16, 32, 64 or more) and may select a certain transmission beam or beam direction to communicate with the UE 215 based on the location of the UE 215 in relation to the location of the TRPs 205 and/or any other environmental factors such as reflectors and/or scatterers in the surrounding. For example, the second TRP 205b may select a transmission beam that provides a best quality (e.g., with the highest receive signal strength) for transmission to the UE 215. The TRP 205b may also select a reception beam that provides a best quality (e.g., with the highest receive signal strength) for reception from the UE 215. As illustrated in FIG. 2, the TRP 205b may generate three beams 204a, 204b, and 204c. The TRP 205b may determine that it may utilize the beam 204b or the beam 204c to communicate with the UE 215, for example, based on a beam discovery or beam selection procedure.

As explained above, one or both of the TRPs 205 may schedule the UE 215 for an UL communication or a DL communication over a frequency band. For the purposes of the present disclosure, a frequency band may include a component carrier (CC) and/or a bandwidth part (BWP), for example. In single-DCI mTRP communications, a DCI from one of the TRPs (e.g., TRP 205a) may schedule communications for the first TRP 205a and the second TRP 205b. In multi-DCI (mDCI) mTRP communications, each TRP 205 may transmit DCI to the UE 215 to schedule communications. FIG. 2 may illustrate a mDCI mTRP communication scenario, whereby the first TRP 205a schedules DL and/or UL communications with the UE 215 by a first communication link 207, and the second TRP 205b schedules DL and/or UL communications with the UE 215 by a second communication link 208. In some aspects, a UE 215 may be configured with carrier aggregation to communicate with one or both of the TRPs 205 using one or more serving cells. The serving cells may include, for example, a primary cell (PCell), one or more secondary cells (SCells), a PUCCH secondary cell (PSCell), and/or a special cell (SpCell). In some aspects, one or more of the serving cells may be configured for mDCI mTRP communications, and one or more cells may be configured for single-TRP communications. A cell may be configured for mDCI mTRP communications if the cell configuration indicates two CORESET pool index values and two timing advance groups (TAGs). For example, a mDCI cell may indicate two CORESETPoolIndex values and two TAG indicators. A single-TRP cell configuration may indicate a single TAG indicator and/or a single CORESETPoolIndex value.

In some aspects, a sDCI and/or a mDCI may be associated with a format, and may include one or more fields or parameters to indicate a UE with one or more parameters for a UL channel or communication. For example, a DCI may include frequency resource assignments, time resource assignments, beam-related parameters, power control parameters, and/or any other suitable or relevant information for the UE to transmit a UL communication in a UL channel. For example, DCI may indicate one or more TCI codepoints, TCI states, power control (PC) commands, frequency allocation of a scheduled UL communication, time allocation of a scheduled UL communication, antenna port indication, and/or any other relevant parameter for a UL communication. Further, RRC messages and/or MAC-CEs may be used to configure or activate UL communications. In some aspects, a RRC message may configured one or more CORESET pool index values, TAGs, and/or any other cell configuration associated with a UL channel or configuration.

In some instances, a UE may be indicated and/or configured to transmit two UL communications to two different TRPs during a same time period. For example, the UE may be configured for SDM mTRP communication and the two UL communications may be scheduled or indicated during a same time period and using the same frequency resources. In another aspect, the communications may be scheduled for different portions of a same inter-band CC, for the UL communications may be scheduled for different CCs within a same band. However, in some instances, the two UL communications may not be capable of simultaneous transmission. For example, in some aspects, the UL communications may be indicated with different TCI states that are not capable of simultaneous transmission. In other aspects, the UL communications may be indicated with the same TCI state and overlapping frequency resources such that the two overlapping UL communications may not be simultaneously transmitted. The scheduling, indication, and/or activation of two UL channels during a same time period that are not capable of simultaneous transmission may be referred to as a collision, or scheduling collision.

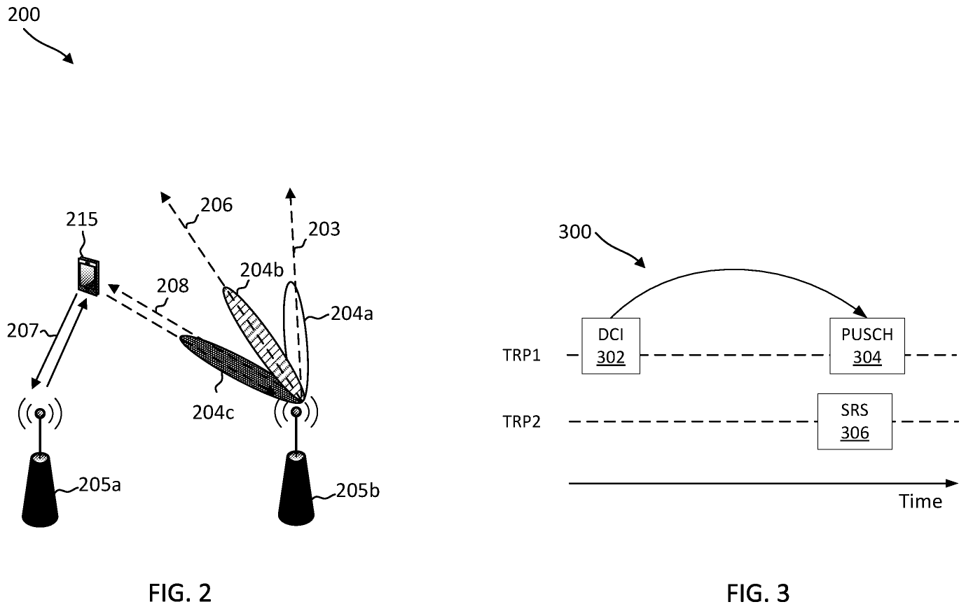

FIG. 3 illustrates a UL mTRP scheduling collision scenario 300. The scenario 300 may illustrate communication links between a UE, a first TRP (TRP1), and a second TRP (TRP2). The UE may be configured for mTRP communications with both of TRP1 and TRP2. The dashed lines may refer to the communication links. In some aspects, the UE is configured to communicate with both TRPs using a single CC. In some aspects, the single CC may be intra-band (within a same frequency band), or inter-band (spanning two frequency bands). In other aspects, TRP1 may communicate with the UE using a first CC, and the TRP2 may communicate with the UE using a second CC, where the first CC and the second CC are in a same frequency band. In some aspects, the two TRPs may communicate with the UE using a same logical cell. In other aspects, TRP1 may communicate with the UE using a first cell (e.g., primary cell/special cell), and TRP2 may communicate with the UE using a second cell (e.g., secondary cell). In some aspects, the mTRP communication scenario may use frequency division multiplexing (FDM), time division multiplexing (TDM), or spatial division multiplexing (SDM).

The UE may receive, from TRP1, a DCI 302 scheduling a PUSCH 304. In some aspects, the DCI 302 may be a mDCI scheduling the PUSCH 304 for communication back to TRP1. In other aspects, the DCI 302 may be sDCI scheduling the PUSCH 304 for communication to TRP2 or back to TRP1. The UE may also be indicated, configured, or otherwise scheduled to transmit a SRS 306 to TRP2. However, other UL communications and/or UL channels are also contemplated instead of or in addition to the SRS 306. For example, the UL may be indicated or configured to transmit a PRACH, PUCCH, and/or any other suitable UL channel. As shown, the SRS 306 at least partially coincides or overlaps in time with the PUSCH 304. Further, as explained above, the PUSCH 304 and SRS 306 may be scheduled on the same or overlapping frequency resources, in intra-band frequency resources, and/or within a same CC. Further, the DCI 302 may indicate, or be associated with, a first TCI state so that the UE transmits the PUSCH 304 to TRP1 based on a suitable spatial filter, for example. Similarly, the SRS 306 may be configured or indicated with a second TCI state for communication to TRP2 using a suitable spatial filter. In some aspects, the UE may not be able to transmit the PUSCH 304 and the SRS 306 simultaneously, using the first TCI state and second TCI state. Accordingly, the PUSCH 304 and the SRS 306 may be described as colliding, or having a UL scheduling collision.

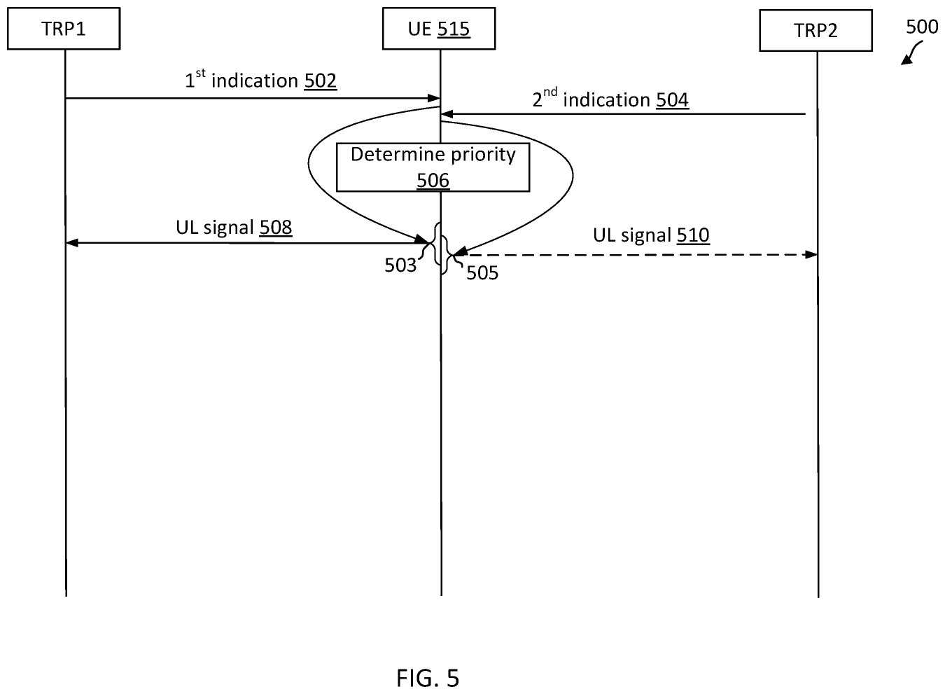

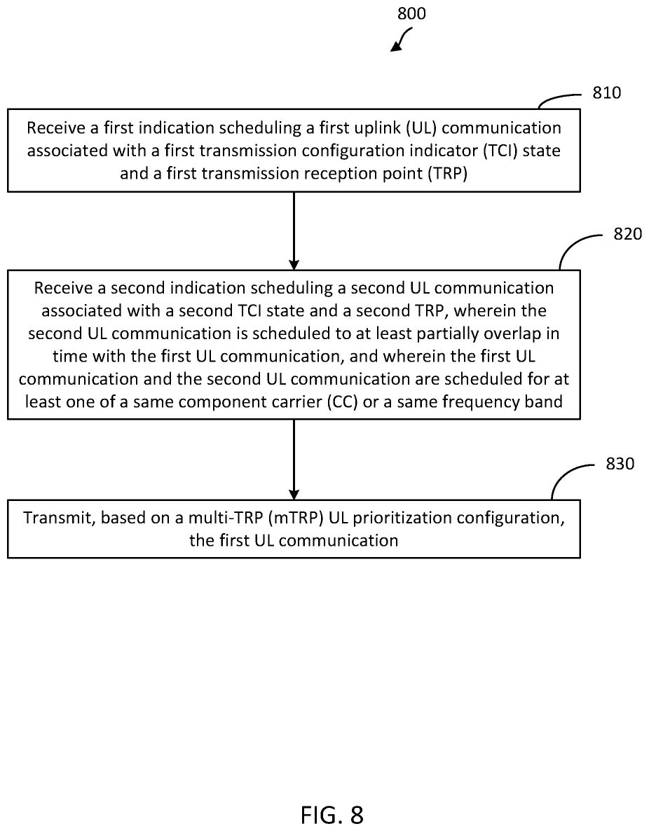

The present disclosure describes methods, schemes, and mechanisms for resolving, avoiding, and/or handling UL collisions in mTRP communication scenarios based on a mTRP prioritization configuration. In some aspects, the mTRP prioritization configuration indicates or assigns different priorities to the PUSCH 304 and the SRS 306 based on, for example, UL channel type, corresponding TRP, TCI state, time allocation, and/or any other suitable parameter of the UL communications. A method for handling UL collisions in an mTRP communication scenario is illustrated and described in FIGS. 5 and 8.

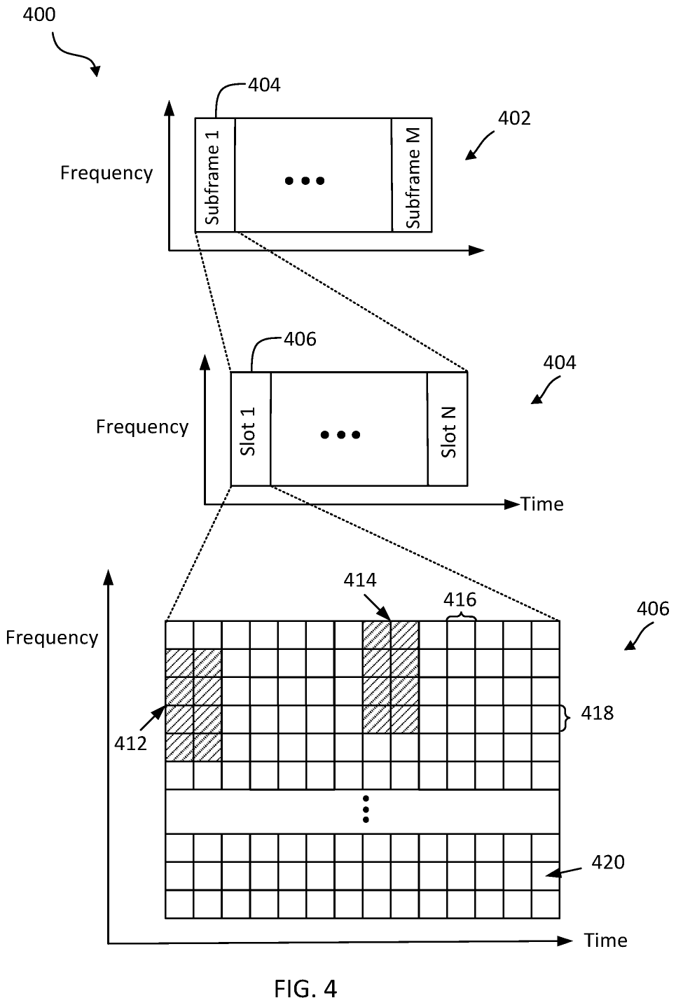

FIG. 4 is a timing diagram illustrating a transmission frame structure 400 according to some embodiments of the present disclosure. The transmission frame structure 400 may be employed by BSs such as the BSs 105 and UEs such as the UEs 115 in a network such as the network 100 for communications. In particular, the BS may communicate with the UE using time-frequency resources configured as shown in the transmission frame structure 400. In FIG. 4, the x-axes represent time in some arbitrary units and the y-axes represent frequency in some arbitrary units. The transmission frame structure 400 includes a radio frame 402. The duration of the radio frame 402 may vary depending on the embodiments. In an example, the radio frame 402 may have a duration of about ten milliseconds. The radio frame 402 includes M number of subframes 404, where M may be any suitable positive integer. In an example, M may be about 10.

Each subframe 404 may contain N slots 406, where N is any suitable positive number including 1. Each slot 406 includes a number of subcarriers 418 in frequency and a number of symbols 416 in time. The number of subcarriers 418 and/or the number of symbols 416 in a slot 406 may vary depending on the embodiments, for example, based on the channel bandwidth, the subcarrier spacing (SCS), and/or the cyclic prefix (CP) mode. One subcarrier 418 in frequency and one symbol 416 in time forms one resource element (RE) 420 for transmission.

A BS (e.g., BS 105 in FIG. 1A) may schedule a UE (e.g., UE 115 in FIG. 1A) for UL and/or DL communications at a time-granularity of slots 406. A BS 105 may schedule a UE 115 to monitor for PDCCH transmissions by instantiating a search space associated with a CORESET 412. The search space may also be instantiated with associated CORESET 414. Thus, as illustrated in the example of FIG. 4, there are two CORESETs, and therefore two monitoring occasions, within the slot 406 that are part of the search space the UE 115 monitors for control information from the BS 105.

While FIG. 4 illustrates two CORESETs, 412 and 414, for purposes of simplicity of illustration and discussion, it will be recognized that embodiments of the present disclosure may scale to many more CORESETs, for example, about 3, 4 or more. Each CORESET may include a set of resources spanning a certain number of subcarriers 418 and a number of symbols 416 (e.g., about 1, 2, or 3) within a slot 406. As an alternative to multiple different CORESETs within a slot 406, one or more of the many CORESETs may be in a different slot than the others. Each CORESET has an associated control channel element (CCE) to resource element group (REG) mapping. A REG may include a group of REs 420. The CCE defines how DL control channel data may be transmitted.

A BS 105 may configure a UE 115 with one or more search spaces by associating a CORESET 412 with a starting position (e.g., a starting slot 406), a symbol 416 location within a slot 406, a periodicity or a time pattern, and candidate mapping rules. For examples, a search space may include a set of candidates mapped to CCEs with aggregation levels of 1, 4, 4, 8, and/or 12 CCEs. As an example, a search space may include the CORESET 412 starting at the first symbol 416 indexed within a starting slot 406. The search space may also include the CORESET 414 starting at a later symbol index within the starting slot 406. The exemplary search space may have a periodicity of about five slots and may have candidates at aggregation levels of 1, 4, 4, and/or 8.

The UE 115 may perform blind decoding in the search spaces to search for DL control information (e.g., slot format information and/or scheduling information) from the BS. In some examples, the UE may search a subset of the search spaces based on certain rules, for example, associated with the UE's channel estimation and/or blind decoding capabilities. One such example of DL control information the UE 115 may be blind decoding for is a PDCCH from the BS 105.

As shown in FIG. 4, CORESET 412 and CORESET 414 may be at different frequencies from each other. The CORESETs can be non-contiguous as shown, or they may be contiguous. The frequency ranges of CORESET 412 and CORESET 414 may overlap or not (e.g., as illustrated in FIG. 4, the frequency ranges partially overlap, and therefore are different from each other). In some aspects, the frequency offset between the CORESETs is a multiple of six RBs, or some other offset. According to the example of FIG. 4, each of CORESET 412 and CORESET 414 may carry a different PDCCH transmission (or none at all, though part of the search space for the UE 115). CORESET 412 and CORESET 414 can have other characteristics which are different from each other than just frequency (or instead of frequency). For example, they can differ in CCE-to-REG mapping and/or REG bundling. Or, they can also be associated with different TCI states, thereby being associated with different beams. In addition, the CCE index of a PDCCH monitoring occasion may be different across CORESETs. Other forms of diversity between CORESETs could be achieved as well, including some combination of differing characteristics (such as all of the above differences together or a subset thereof).

FIG. 5 is a signaling diagram illustrating a mTRP communication method 500 according to some aspects of the present disclosure. The method 500 is employed by a first TRP (TRP1), a second TRP (TRP2), and a UE 515. In some aspects, one or both of the TRPs may be one of the BSs 105 in the network 100. In other aspects, one or both of the TRPs may be another type of wireless node or connection point. In some aspects, the TRPs may be referred to as network devices or network entities. In some aspects, one or both of the TRPs may include an aggregated BS and/or one or more portions of a disaggregated BS, as described above with respect to FIG. 1B. In some aspects, the UE 515 may be one of the UEs 115 of the network 100. The UE 515 may be configured for mTRP communications with both TRP1 and TRP2. However, it will be understood that the UE 515 may be configured for mTRP communications with more than two TRPs, including three, four, five, six, and/or any other suitable number of TRPs.

As explained above, the UE 515 may be configured for single-DCI (sDCI) mTRP communications, or multi-DCI (mDCI) mTRP communications. In sDCI mTRP communications, the UE 515 may receive scheduling DCI from one of TRP1 or TRP2 for DL and/or UL communications communicated with both TRP 1 and TRP 2. In mDCI mTRP communications, the UE 515 may receive scheduling DCIs from each of TRP1 and TRP2 for DL and/or UL communications with each respective TRP. In some aspects, the UE 515 is configured to communicate with both TRPs using a single CC. In some aspects, the single CC may be intra-band (within a same frequency band), or inter-band (spanning two frequency bands). In other aspects, TRP1 may communicate with the UE using a first CC, and the TRP2 may communicate with the UE using a second CC, where the first CC and the second CC are in a same frequency band. In some aspects, the two TRPs may communicate with the UE 515 using a same logical cell. In other aspects, TRP1 may communicate with the UE 515 using a first cell (e.g., primary cell/special cell of a first physical cell index), and TRP2 may communicate with the UE 515 using a second cell (e.g., secondary cell of a second physical cell index). In some aspects, the mTRP communication scenario may use frequency division multiplexing (FDM), time division multiplexing (TDM), or spatial division multiplexing (SDM).

At action 502, the UE 515 receives, from TRP1, a first indication associated with a first UL communication scheduled for a first time period 503. In some aspects, the first indication may comprise a first DCI scheduling the first UL communication for the first time period 503 on a first set of frequency resources. In some aspects, the first DCI may indicate a first TCI state and the UL transmission using a first TRP (e.g., TRP1). In other aspects, the UE 515 may receive a different DCI, a MAC-CE, a RRC message, and/or any other suitable type of indication activating, configuring, and/or otherwise indicating the UE 515 to communicate the first UL communication. In some aspects, action 502 comprises receiving more than one of a first DCI, a second DCI, a MAC-CE, a RRC message, and/or a combination thereof. In some aspects, a same field of the first DCI may indicate both the first TCI state and the UL transmission for the TRP1. In other aspects, a first DCI may indicate the first TCI state and a second DCI may indicate the UL transmission for the TRP1. In some aspects, the method 500 may further include the UE 515 receiving a RRC configuration indicating a CORESET Pool Index, and the CORESET Pool Index value may be associated with TRP1.

At action 504, the UE 515 receives, from TRP2, a second indication associated with a second UL communication scheduled for a second time period 505. The second time period 505 at least partially overlaps in time with the first time period 503. In some aspects, the second indication may comprise a DCI scheduling the second UL communication for the second time period 505 on a second set of frequency resources. The second set of frequency resources may be the same as or different from the first set of frequency resources. For example, the first and second frequency resources may be associated with at least one of a same CC and/or a same frequency band, as explained above. In some aspects, the DCI may indicate a second TCI state and the UL transmission for a second TRP (e.g., TRP2). In other aspects, the UE 515 may receive a different DCI, a MAC-CE, a RRC message, and/or any other suitable type of indication activating, configuring, and/or otherwise indicating the UE 515 to communicate the second UL communication. In some aspects, action 504 comprises receiving more than one of a third DCI, a fourth DCI, a MAC-CE, a RRC message, and/or a combination thereof. In some aspects, a same field of the DCI received at action 504 may indicate both the second TCI state and the UL transmission for the TRP2. In other aspects, the DCI may indicate the second TCI state and a different DCI may indicate the UL transmission for TRP2. In some aspects, the method 500 may further include the UE 515 receiving a RRC configuration indicating a CORESET Pool Index, and the CORESET Pool Index value may be associated with TRP2.

Based on the first and second UL communications indicated at actions 502 and 504 coinciding and time, and based on their respective indicated TCI states, the first UL communication may collide with the second UL communication in time. In other words, the first UL communication and the second UL communication may not be capable of simultaneous transmission by the UE. For example, the first and second TCI states may not be configured for or capable of simultaneous transmission using the frequency resources indicated for the UL communications. Accordingly, at action 506, the UE 515 determines a prioritization of the first UL communication and the second UL communication based on a mTRP UL prioritization configuration. In some aspects, the mTRP UL prioritization configuration may comprise a set of hardcoded or preconfigured rules that may be used to prioritize colliding UL communications in a mTRP communication scenario. In other aspects, the mTRP UL prioritization configuration may be semi-statically and/or dynamically configurable such that the prioritization configuration may be updated or modified by the network.

The mTRP UL prioritization configuration may configure the UE 515 to assign priorities to, or prioritize, the UL communications based on one or more of: the UL channel types associated with the UL communications, the indicated frequency resources indicated for the UL communications, the indicated time resources indicated for the UL communications, the information type associated with the UL communications (e.g., what information is to be carried in each channel), the TRPs associated with the UL communications, the indication type of the UL communications (e.g., DCI-scheduled, RRC-configured, MAC-CE-activated, etc.), and/or any other suitable prioritization.

In this regard, in one aspect, the first UL communication is associated with a first UL channel type, and the second UL communication is associated with a second UL channel type different from the first UL channel type. In some aspects, the mTRP UL prioritization configuration indicates that the first uplink channel type has a higher priority than the second uplink channel type. In some aspects, the mTRP UL prioritization configuration may designate a PRACH as having a higher priority than a PUCCH. In some aspects, the mTRP UL prioritization configuration may designate a PUCCH as having a higher priority than a PUSCH. In another aspect, the mTRP UL prioritization configuration may designate a PUSCH as having a higher priority than a SRS. In other aspects, the mTRP UL prioritization configuration may designate a PUCCH as having a higher priority than a PRACH. In other aspects, the mTRP UL prioritization configuration may designate a PUSCH as having a higher priority than a PUCCH.

In another aspect, the mTRP UL priorities of the first UL communication and the second UL communication may be based on a combination of a UL channel type and the information carried in or associated with the first and second UL communications. In some aspects, the mTRP UL prioritization configuration may designate a PRACH as having a higher priority than a PUCCH carrying HARQ-ACK information, a scheduling request (SR), and/or link recovery request (LRR), and/or a PUSCH transmission carrying HARQ-ACK information. In some aspects, the mTRP UL prioritization configuration may designate the PUCCH carrying HARQ-ACK information, SR, and/or LRR, and/or the PUSCH transmission carrying HARQ-ACK information as having a higher priority than a PUCCH transmission carrying channel state information (CSI) and/or a PUSCH transmission carrying CSI. In another aspect, the mTRP UL prioritization configuration may designate the PUCCH transmission carrying channel state information (CSI) and/or the PUSCH transmission carrying CSI as having a higher priority than a PUSCH transmission that does not include HARQ-ACK information or CSI. In another aspect, the mTRP UL prioritization configuration may designate the PUCCH transmission carrying channel state information (CSI) and/or the PUSCH transmission carrying CSI as having a higher priority than a PUSCH transmission on a Pcell for type 2 random access procedures. In another aspect, the mTRP UL prioritization configuration may designate the PUSCH transmission on a Pcell for type 2 random access procedures and/or the PUSCH transmission without HARQ-ACK information or CSI as having a higher priority than a SRS transmission. In some aspects, the mTRP UL prioritization configuration may designate aperiodic SRS as having a higher priority than semi-persistent and/or periodic SRS. In some aspects, the mTRP UL prioritization configuration may designate aperiodic SRS as having a higher priority than a PRACH transmission on a serving cell on than the Pcell. However, other prioritizations are also contemplated by the present disclosure instead of or in addition to those explicitly mentioned above. For example, in some aspects, the mTRP UL prioritization configuration may indicate that PUSCH transmissions carrying HARQ-ACK information or CSI have a higher priority than PUCCH transmissions having HARQ-ACK information. In another aspect, the mTRP UL prioritization configuration may indicate that an aperiodic SRS has a higher priority than a PUSCH that does not include HARQ-ACK and/or CSI.

In another example, the mTRP UL prioritization configuration may result in the UE 515 assigning priorities based on the TRP associated with the UL communication. For example, in some aspects, the first UL communication is associated with a TRP1, and the second UL communication is associated with TRP2. The TRPs associated with each UL communication may be indicated based on the TCI state(s) indicated in the scheduling DCI, and/or the CORESET pool index associated with, indicated for, or configured for the UL communications. In some aspects, the UL communication associated with the TCI state of a lower ID or number may be prioritized by the UE 515 for transmission.

In another aspect, the mTRP UL prioritization configuration may result in the UE 515 assigning priorities based on the indication type of each of the first indication and the second indication. For example, the first indication may be associated with a first indication type, and the second indication may be associated with a second indication type. In one example, the first indication type may be a DCI scheduling the first UL communication, and the second indication type may be a RRC message or a MAC-CE configuring and/or activating one or more occasions of a UL channel associated with the second UL communication. In some aspects, the mTRP UL prioritization configuration may cause the UE 515 to assign a higher priority to the DCI-scheduled first UL communication. In other aspects, the mTRP UL prioritization configuration may assign a higher priority to the RRC-configured second UL communication, and/or to the MAC-CE-activated second UL communication. In some aspects, the mTRP UL prioritization configuration may cause the UE 515 to assign a higher priority to MAC-CE activated UL communications compared to RRC-configured UL communications.

In another aspect, the mTRP UL prioritization configuration may result in the UE 515 assigning priorities based on the time domain allocations for the first UL communication and the second UL communication. For example, in some aspects, the mTRP UL prioritization configuration may cause the UE 515 to assign relative priorities based on the starting symbol, ending symbol, and/or time duration of the first UL communication and second UL communication. For example, the mTRP indication may cause the UE 515 to prioritize the first UL communication based on the first UL communication having an earlier starting symbol than the second UL communication. In another aspect, the mTRP indication may cause the UE 515 to prioritize the first UL communication based on the first UL communication having an earlier ending symbol relative to the second UL communication. In another aspect, mTRP indication may cause the UE 515 to prioritize the first UL communication based on the first UL communication having a shorter duration, or a longer duration, relative to the second UL communication. In some aspects, the mTRP UL prioritization configuration may cause the UE 515 to prioritize UL communications based on a combination of time domain allocation parameters. For example, if the first UL communication and the second UL communication are scheduled for a same starting symbol, the UE 515 may prioritize the UL communication having the earlier ending symbol or later ending symbol. In another aspect, if the first UL communication and the second UL communication are associated with a same starting symbol, the UE 515 may prioritize the UL communication having the longer duration or the shorter duration.

In some aspects, the mTRP UL prioritization configuration may cause the UE 515 to prioritize UL communications based on a combination of the parameters indicated above. For example, the UE 515 may first use UL channel type to determine the priorities, but may consider TRP, TCI, indication type, and/or time domain allocation if the UL channel type priorities are the same. In another aspect, the UE 515 may first use indication type to determine the UL priorities, but may use time domain allocation if the indication type priorities are the same for both the first UL communication and the second UL communication.

At action 508, the UE 515 transmits, to TRP1 based on the mTRP UL prioritization configuration, the first UL communication. In some aspects, the method 500 may include transmitting both of the colliding UL communications. In this regard, as indicated by the dashed line of action 510, the UE 515 may transmit, to TRP2 based on the UL prioritization configuration, the second UL communication. In some aspects, the UE 515 may transmit the second UL communication based on the same TCI state as the first UL communication. For example, the UE 515 may use the first TCI state for transmitting the second UL communication. In other aspects, the UE 515 may use the second TCI state for transmitting the second UL communication. The UE 515 may use one or more of the parameters or prioritization schemes described above, including indication type, UL channel type, time domain parameters, TRP, and/or TCI state ID, to select the single TCI state for transmitting both the first UL communication and the second UL communication. In some aspects, the transmitting the first UL communication and the second UL communication may be performed using different time domain and/or different frequency domain resources for each configuration. For example, the UE 515 may use FDM or TDM to transmit the first UL communication and the second UL communication using the same TCI state. In some aspects, by selecting the single TCI state for both UL channels associated with the UL communications, the TCI state for a UL channel may be reset or updated.

In another aspect, instead of transmitting the first UL communication at action 508, the method 500 may comprise refraining from transmitting either of the first UL communication or the second UL communication based on the first UL communication colliding with the second UL communication. In this regard, the UE 515 may treat as an error case a collision of UL communications that cannot be simultaneously transmitted in an mTRP communication scenario.

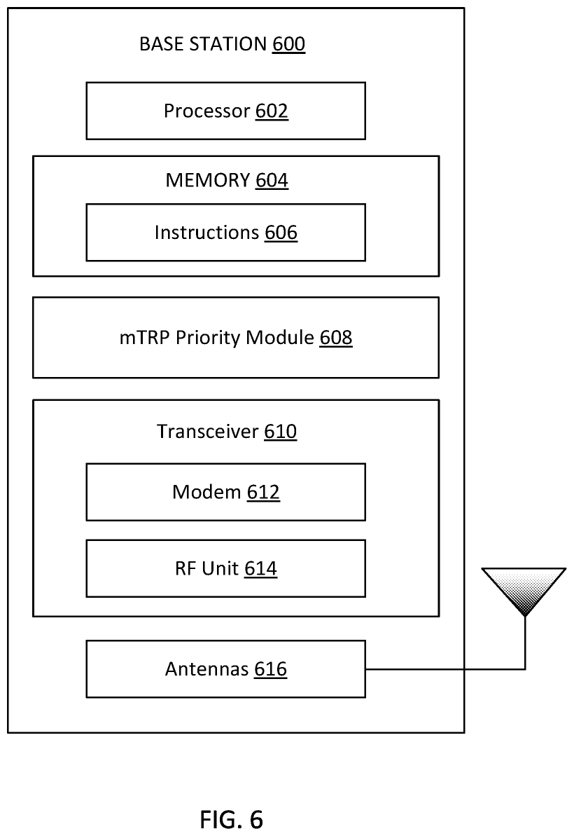

FIG. 6 is a block diagram of an exemplary BS 600 according to some aspects of the present disclosure. The BS 600 may be a BS 105 as discussed in FIG. 1A, and or a TRP as discussed in FIGS. 2 and 5. For example, the BS 600 may be configured as one of multiple TRPs in a network configured for communication with at least one UE, such as one of the UEs 115, 215, 515, and/or 700. As shown, the BS 600 may include a processor 602, a memory 604, a mTRP Priority Module 608, a transceiver 610 including a modem subsystem 612 and a RF unit 614, and one or more antennas 616. These elements may be coupled with one another. The term “coupled” may refer to directly or indirectly coupled or connected to one or more intervening elements. For instance, these elements may be in direct or indirect communication with each other, for example via one or more buses.

The processor 602 may have various features as a specific-type processor. For example, these may include a CPU, a DSP, an ASIC, a controller, a FPGA device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 604 may include a non-transitory computer-readable medium. The memory 604 may store instructions 606. The instructions 606 may include instructions that, when executed by the processor 602, cause the processor 602 to perform operations described herein, for example, aspects of FIGS. 2 and 5. Instructions 606 may also be referred to as program code. The program code may be for causing a wireless communication device to perform these operations, for example by causing one or more processors (such as processor 602) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The mTRP Priority Module 608 may be implemented via hardware, software, or combinations thereof. For example, the mTRP Priority Module 608 may be implemented as a processor, circuit, and/or instructions 606 stored in the memory 604 and executed by the processor 602. In some examples, the mTRP Priority Module 608 can be integrated within the modem subsystem 612. For example, the mTRP Priority Module 608 can be implemented by a combination of software components (e.g., executed by a DSP or a general processor) and hardware components (e.g., logic gates and circuitry) within the modem subsystem 612. The mTRP Priority Module 608 may communicate with one or more components of BS 600 to implement various aspects of the present disclosure, for example, aspects of FIGS. 2 and 5.

In some aspects, the mTRP Priority Module 608 is configured to transmit, or cause the transceiver 610 to transmit, an indication for a UL communication associated with a TCI state and a TRP. In some aspects, the first UL communication is scheduled to at least partially overlap in time with a second UL communication associated with a second TRP and a second TCI state. In some aspects, the first UL communication and the second UL communication may be scheduled on at least one of a same CC or a same frequency band. In another aspect, the mTRP Priority Module 608 is configured to receive, based on a mTRP UL prioritization configuration, the first UL communication. In some aspects, the mTRP Priority Module 608 may be configured to cause the transceiver 610 to transmit the mTRP UL prioritization configuration to at least one UE. In other aspects, the mTRP priority module 608 is configured to transmit, or cause the transceiver 610 to transmit, the indication by transmitting a DCI including a scheduling grant, a TCI state indication, and/or any other parameter associated with the first UL communication. In other aspects, the mTRP priority module 608 is configured to transmit, or cause the transceiver 610 to transmit, the indication by transmitting a RRC configuration, a MAC-CE, and/or any other suitable indication configuring, activating, or otherwise indicating the first UL communication.

In some aspects, the mTRP Priority Module 608 may be configured to perform one or more aspects of the method 500.

As shown, the transceiver 610 may include the modem subsystem 612 and the RF unit 614. The transceiver 610 can be configured to communicate bi-directionally with other devices, such as the UEs 115 and/or BS 600 and/or another core network element. The modem subsystem 612 may be configured to modulate and/or encode data according to a MCS, e.g., a LDPC coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data (e.g., RRC table(s) for channel access configurations, scheduling grants, channel access configuration activation, RRC configurations, PDSCH data, PDCCH DCI, etc.) from the modem subsystem 612 (on outbound transmissions) or of transmissions originating from another source such as a UE 115, 215, and/or UE 700. The RF unit 614 may be further configured to perform analog beamforming in conjunction with the digital beamforming. Although shown as integrated together in transceiver 610, the modem subsystem 612 and/or the RF unit 614 may be separate devices that are coupled together at the BS 600 to enable the BS 600 to communicate with other devices.

The RF unit 614 may provide the modulated and/or processed data, e.g. data packets (or, more generally, data messages that may contain one or more data packets and other information), to the antennas 616 for transmission to one or more other devices. The antennas 616 may further receive data messages transmitted from other devices and provide the received data messages for processing and/or demodulation at the transceiver 610. The transceiver 610 may provide the demodulated and decoded data (e.g., channel sensing reports, PUCCH UCI, PUSCH data, etc.) to the mTRP Priority Module 608 for processing. The antennas 616 may include multiple antennas of similar or different designs in order to sustain multiple transmission links.

In an aspect, the BS 600 can include multiple transceivers 610 implementing different RATs (e.g., NR and LTE). In an aspect, the BS 600 can include a single transceiver 610 implementing multiple RATs (e.g., NR and LTE). In an aspect, the transceiver 610 can include various components, where different combinations of components can implement different RATs.

Further, in some aspects, the processor 602 is coupled to the memory 604 and the transceiver 610. The processor 602 is configured to communicate, with a second wireless communication device via the transceiver 610, a plurality of channel access configurations. The processor 602 is further configured to communicate, with the second wireless communication device via the transceiver 610, a scheduling grant for communicating a communication signal in an unlicensed band, where the scheduling grant includes an indication of a first channel access configuration of the plurality of channel access configurations. The processor 602 is further configured to communicate, with the second wireless communication device in the unlicensed band via the transceiver 610 based on the first channel access configuration, the communication signal.

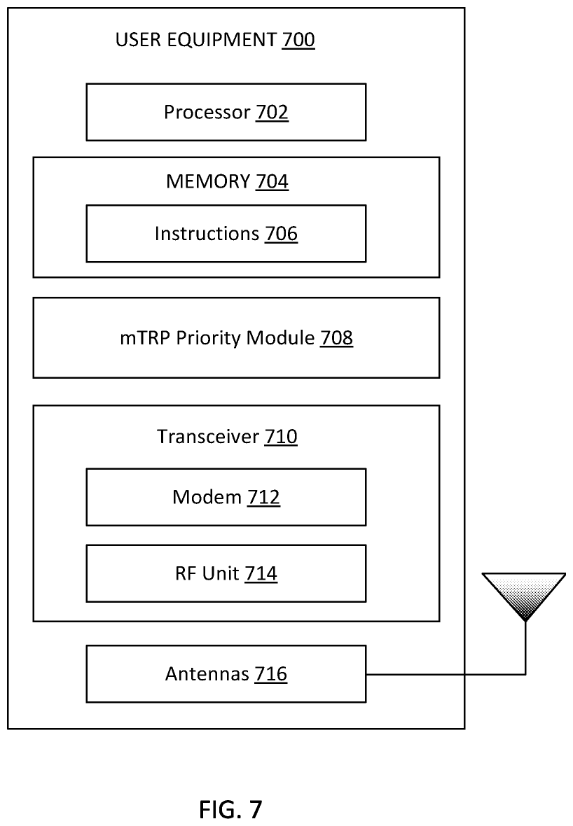

FIG. 7 is a block diagram of an exemplary UE 700 according to some aspects of the present disclosure. The UE 700 may be a UE 115 as discussed in FIG. 1A or a UE 215 as discussed in FIG. 2, or the UE 515 as discussed in FIG. 5. As shown, the UE 700 may include a processor 702, a memory 704, a mTRP Priority Module 708, a transceiver 710 including a modem subsystem 712 and a radio frequency (RF) unit 714, and one or more antennas 716. These elements may be coupled with one another. The term “coupled” may refer to directly or indirectly coupled or connected to one or more intervening elements. For instance, these elements may be in direct or indirect communication with each other, for example via one or more buses.

The processor 702 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 704 includes a non-transitory computer-readable medium. The memory 704 may store, or have recorded thereon, instructions 706. The instructions 706 may include instructions that, when executed by the processor 702, cause the processor 702 to perform the operations described herein with reference to a UE 115 or an anchor in connection with aspects of the present disclosure, for example, aspects of FIGS. 2 and 5. Instructions 706 may also be referred to as code, which may be interpreted broadly to include any type of computer-readable statement(s) as discussed above with respect to FIG. 9.

The mTRP Priority Module 708 may be implemented via hardware, software, or combinations thereof. For example, the mTRP Priority Module 708 may be implemented as a processor, circuit, and/or instructions 706 stored in the memory 704 and executed by the processor 702. In some aspects, the mTRP Priority Module 708 can be integrated within the modem subsystem 712. For example, the mTRP Priority Module 708 can be implemented by a combination of software components (e.g., executed by a DSP or a general processor) and hardware components (e.g., logic gates and circuitry) within the modem subsystem 712. The mTRP Priority Module 708 may communicate with one or more components of UE 700 to implement various aspects of the present disclosure, for example, aspects of FIGS. 2 and 5.

In some aspects, the mTRP Priority Module 708 is configured to receive, via the transceiver 710, an indication for a first UL communication associated with a first TCI state and a first TRP. In another aspect, the mTRP Priority Module 708 is further configured to receive, via the transceiver 710, an indication for a second UL communication associated with a second TCI state and a second TRP. In some aspects, the first UL communication is scheduled to at least partially overlap in time with the second UL communication. In some aspects, the first UL communication and the second UL communication may be scheduled on at least one of a same CC or a same frequency band. In another aspect, the mTRP Priority Module 708 is configured to transmit, based on a mTRP UL prioritization configuration, the first UL communication. In this regard, the mTRP Priority Module 708 may be configured to select or determine, based on the mTRP UL prioritization configuration, one of the first UL communication or the second UL communication based on one or more of the indication type, the associated TCI state, the associated TRP, the UL channel type, the time domain for the UL communication, the associated CORESET pool index, and/or any other suitable parameter as described herein to prioritize one UL communication over the other colliding UL communication. In some aspects, the mTRP Priority Module 708 may be configured to cause the transceiver 710 to receive the mTRP UL prioritization configuration from a network entity, for example. In other aspects, the mTRP priority module 708 is configured to receive, or cause the transceiver 710 to receive, the indications by receiving one or more of DCI including a scheduling grant, a TCI state indication, and/or any other parameter associated with the first UL communication. In other aspects, the mTRP priority module 708 is configured to receive, or cause the transceiver 710 to receive, the indications by receiving one or more of a RRC configuration, a MAC-CE, and/or any other suitable indication configuring, activating, or otherwise indicating the UL communications.

In some aspects, the mTRP Priority Module 708 may be configured to perform one or more aspects of the method 500.

As shown, the transceiver 710 may include the modem subsystem 712 and the RF unit 714. The transceiver 710 can be configured to communicate bi-directionally with other devices, such as the BSs 105 and 600. The modem subsystem 712 may be configured to modulate and/or encode the data from the memory 704 and/or the mTRP Priority Module 708 according to a modulation and coding scheme (MCS), e.g., a low-density parity check (LDPC) coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data (e.g., channel sensing reports, PUCCH UCI, PUSCH data, etc.) or of transmissions originating from another source such as a UE 115, a BS 105, or an anchor. The RF unit 714 may be further configured to perform analog beamforming in conjunction with the digital beamforming. Although shown as integrated together in transceiver 710, the modem subsystem 712 and the RF unit 714 may be separate devices that are coupled together at the UE 700 to enable the UE 700 to communicate with other devices.

The RF unit 714 may provide the modulated and/or processed data, e.g. data packets (or, more generally, data messages that may contain one or more data packets and other information), to the antennas 716 for transmission to one or more other devices. The antennas 716 may further receive data messages transmitted from other devices. The antennas 716 may provide the received data messages for processing and/or demodulation at the transceiver 710. The transceiver 710 may provide the demodulated and decoded data (e.g., RRC table(s) for channel access configurations, scheduling grants, channel access configuration activation, timing advance configurations, RRC configurations, PUSCH configurations, SRS resource configurations, PUCCH configurations, BWP configurations, PDSCH data, PDCCH DCI, etc.) to the mTRP Priority Module 708 for processing. The antennas 716 may include multiple antennas of similar or different designs in order to sustain multiple transmission links.

In an aspect, the UE 700 can include multiple transceivers 710 implementing different RATs (e.g., NR and LTE). In an aspect, the UE 700 can include a single transceiver 710 implementing multiple RATs (e.g., NR and LTE). In an aspect, the transceiver 710 can include various components, where different combinations of components can implement different RATs.

Further, in some aspects, the processor 702 is coupled to the memory 704 and the transceiver 710. The processor 702 is configured to communicate, with a second wireless communication device via the transceiver 710, one or more timing advance configurations and/or one or more cell configurations. The processor 702 may be further configured to select one or more reference cells for communication in a mTRP communication scenario, and to determine one or more reference timings and/or one or more timing advances based on the one or more reference cells.

FIG. 8 is a flow diagram illustrating a wireless communication method 800 according to some aspects of the present disclosure. Aspects of the method 800 can be executed by a computing device (e.g., a processor, processing circuit, and/or other suitable component) of a wireless communication device or other suitable means for performing the blocks. In one aspect, a UE, such as one of the UEs 115, 515, and/or 700, may utilize one or more components, such as the processor 702, the memory 704, the mTRP Priority Module 708, the transceiver 710, the modem 712, the RF unit 714, and the one or more antennas 716, to execute the blocks of method 800. The method 800 may employ similar mechanisms as described in FIG. 5. In some aspects, the network entity may include an aggregated BS and/or a disaggregated BS as described above with respect to FIGS. 1A and 1B. The network entity may be configured as one of a plurality of transmission-reception points (TRPs) in a mTRP communication scenario. Accordingly, aspects of the method 800 may be described with reference to one or more TRPs and one or more UEs. As illustrated, the method 800 includes a number of enumerated blocks, but aspects of the method 800 may include additional blocks before, after, and in between the enumerated blocks. In some aspects, one or more of the enumerated blocks may be omitted or performed in a different order.

At block 810, the UE receives a first indication scheduling or configuring a first UL communication associated with a first TCI state and a first TRP. In some aspects, the UE may receive the first indication from the first TRP. In other aspects, the UE may receive the first indication from a TRP different from the first TRP, such as a second TRP. In this regard, the first indication may comprise a sDCI or a mDCI, in some aspects. In some aspects, the first indication may include a DCI including a scheduling grant for the first UL communication. For example, the scheduling grant may schedule or indicate a PUSCH, a PUCCH and/or a combination thereof. In other aspects, the first indication may comprise a control message or control signal such as a RRC message or a MAC-CE. In some aspects, the control signal may configure a semi-static UL channel, such as a PUCCH, or a SRS.

At block 820, the UE receives a second indication scheduling or configuring a second UL communication associated with a second TCI state and a second TRP. In some aspects, the UE may receive the second indication from the second TRP. In other aspects, the UE may receive the second indication from a TRP different from the second TRP, such as the first TRP. In this regard, the second indication may comprise a sDCI or a mDCI, in some aspects. In some aspects, the second indication may include a DCI including a scheduling grant for the second UL communication. For example, the scheduling grant may schedule or indicate a PUSCH, a PUCCH and/or a combination thereof. In other aspects, the first indication may comprise a control message or control signal such as a RRC message or a MAC-CE. In some aspects, the control signal may configure a semi-static UL channel, such as a PUCCH, or a SRS.

In some aspects, the second UL communication is scheduled to at least partially overlap in time with the first UL communication. In some aspects, the second UL communication may completely overlap with the first UL communication. In other aspects, the second UL communication may only partially overlap with the first UL communication. In another aspect, the first UL communication and the second UL communication are scheduled for at least one of a same CC or a same frequency band. For example, the first UL communication may be scheduled or indicated for a same CC, where the CC is an inter-band CC. For example, the inter-band CC may occupy at least a portion of a first frequency band and at least a portion of a second frequency band different from the first frequency band. In some aspects, the first UL communication may be scheduled for the portion of the CC in the first frequency band and the second UL communication may be scheduled for the portion of the CC in the second frequency band. In another example, the first UL communication may be scheduled or indicated for a first CC and the second UL communication may be scheduled or indicated for a second CC different from the first CC. In some aspects, the first and second CCs may be in a same frequency band.

In another aspect, the first TCI state and the second TCI state may not be able to be used for simultaneous UL transmissions by the UE. For example, the first TCI state and the second TCI state may be different TCI states, and the UE may not be able to use the first TCI state and the second TCI state to simultaneously transmit the first UL communication and the second UL communication in the indicated frequency resources. Accordingly, the method 800 may include the UE determining or selecting at least one of the first UL communication or the second UL communication based on a mTRP UL prioritization configuration.

At block 830, the UE transmits, based on the mTRP UL prioritization configuration, the first UL communication. In some aspects, the UE may transmit the first UL communication to the first TRP. In some aspects, the UE selects and transmits the first UL communication based on one or more of a channel type of the first UL communication, an information type carried in the first UL communication, a time domain allocation of the first UL communication, the TCI state associated with the first UL communication, and/or the TRP associated with the first UL communication.

In this regard, in one aspect, the first UL communication is associated with a first UL channel type, and the second UL communication is associated with a second UL channel type different from the first UL channel type. In some aspects, the mTRP UL prioritization configuration indicates that the first uplink channel type has a higher priority than the second uplink channel type. In some aspects, the mTRP UL prioritization configuration may designate a PRACH as having a higher priority than a PUCCH. In some aspects, the mTRP UL prioritization configuration may designate a PUCCH as having a higher priority than a PUSCH. In another aspect, the mTRP UL prioritization configuration may designate a PUSCH as having a higher priority than a SRS. In other aspects, the mTRP UL prioritization configuration may designate a PUCCH as having a higher priority than a PRACH. In other aspects, the mTRP UL prioritization configuration may designate a PUSCH as having a higher priority than a PUCCH.

In another aspect, the mTRP UL priorities of the first UL communication and the second UL communication may be based on a combination of a UL channel type and the information carried in or associated with the first and second UL communications. In some aspects, the mTRP UL prioritization configuration may designate a PRACH as having a higher priority than a PUCCH carrying HARQ-ACK information, a scheduling request (SR), and/or link recovery request (LRR), and/or a PUSCH transmission carrying HARQ-ACK information. In some aspects, the mTRP UL prioritization configuration may designate the PUCCH carrying HARQ-ACK information, SR, and/or LRR, and/or the PUSCH transmission carrying HARQ-ACK information as having a higher priority than a PUCCH transmission carrying channel state information (CSI) and/or a PUSCH transmission carrying CSI. In another aspect, the mTRP UL prioritization configuration may designate the PUCCH transmission carrying channel state information (CSI) and/or the PUSCH transmission carrying CSI as having a higher priority than a PUSCH transmission that does not include HARQ-ACK information or CSI. In another aspect, the mTRP UL prioritization configuration may designate the PUCCH transmission carrying channel state information (CSI) and/or the PUSCH transmission carrying CSI as having a higher priority than a PUSCH transmission on a Pcell for type 2 random access procedures. In another aspect, the mTRP UL prioritization configuration may designate the PUSCH transmission on a Pcell for type 2 random access procedures and/or the PUSCH transmission without HARQ-ACK information or CSI as having a higher priority than a SRS transmission. In some aspects, the mTRP UL prioritization configuration may designate aperiodic SRS as having a higher priority than semi-persistent and/or periodic SRS. In some aspects, the mTRP UL prioritization configuration may designate aperiodic SRS as having a higher priority than a PRACH transmission on a serving cell on than the Pcell. However, other prioritizations are also contemplated by the present disclosure instead of or in addition to those explicitly mentioned above. For example, in some aspects, the mTRP UL prioritization configuration may indicate that PUSCH transmissions carrying HARQ-ACK information or CSI have a higher priority than PUCCH transmissions having HARQ-ACK information. In another aspect, the mTRP UL prioritization configuration may indicate that an aperiodic SRS has a higher priority than a PUSCH that does not include HARQ-ACK and/or CSI.

In another example, the mTRP UL prioritization configuration may result in the UE assigning priorities based on the TRP associated with the UL communication. For example, in some aspects, the first UL communication is associated with a the first TRP, and the second UL communication is associated with the second TRP. The TRPs associated with each UL communication may be indicated based on the TCI state(s) indicated in the scheduling DCI, and/or the CORESET pool index associated with, indicated for, or configured for the UL communications. In some aspects, the UL communication associated with the TCI state of a lower ID or number may be prioritized by the UE for transmission.

In another aspect, the mTRP UL prioritization configuration may result in the UE assigning priorities based on the indication type of each of the first indication and the second indication. For example, the first indication may be associated with a first indication type, and the second indication may be associated with a second indication type. In one example, the first indication type may be a DCI scheduling the first UL communication, and the second indication type may be a RRC message or a MAC-CE configuring and/or activating one or more occasions of a UL channel associated with the second UL communication. In some aspects, the mTRP UL prioritization configuration may cause the UE to assign a higher priority to the DCI-scheduled first UL communication. In other aspects, the mTRP UL prioritization configuration may assign a higher priority to the RRC-configured second UL communication, and/or to the MAC-CE-activated second UL communication. In some aspects, the mTRP UL prioritization configuration may cause the UE to assign a higher priority to MAC-CE activated UL communications compared to RRC-configured UL communications.

In another aspect, the mTRP UL prioritization configuration may result in the UE assigning priorities based on the time domain allocations for the first UL communication and the second UL communication. For example, in some aspects, the mTRP UL prioritization configuration may cause the UE to assign relative priorities based on the starting symbol, ending symbol, and/or time duration of the first UL communication and second UL communication. For example, the mTRP indication may cause the UE to prioritize the first UL communication based on the first UL communication having an earlier starting symbol than the second UL communication. In another aspect, the mTRP indication may cause the UE to prioritize the first UL communication based on the first UL communication having an earlier ending symbol relative to the second UL communication. In another aspect, mTRP indication may cause the UE to prioritize the first UL communication based on the first UL communication having a shorter duration, or a longer duration, relative to the second UL communication. In some aspects, the mTRP UL prioritization configuration may cause the UE to prioritize UL communications based on a combination of time domain allocation parameters. For example, if the first UL communication and the second UL communication are scheduled for a same starting symbol, the UE may prioritize the UL communication having the earlier ending symbol or later ending symbol. In another aspect, if the first UL communication and the second UL communication are associated with a same starting symbol, the UE may prioritize the UL communication having the longer duration or the shorter duration.

In some aspects, the mTRP UL prioritization configuration may cause the UE to prioritize UL communications based on a combination of the parameters indicated above. For example, the UE may first use UL channel type to determine the priorities, but may consider TRP, TCI, indication type, and/or time domain allocation if the UL channel type priorities are the same. In another aspect, the UE may first use indication type to determine the UL priorities, but may use time domain allocation if the indication type priorities are the same for both the first UL communication and the second UL communication.

In another aspect, the method 800 may further include the UE transmitting the second UL communication. In some aspects, the UE may transmit the second UL communication based on the same TCI state as the first UL communication. For example, the UE may use the first TCI state for transmitting the second UL communication. In other aspects, the UE may use the second TCI state for transmitting the second UL communication. The UE may use one or more of the parameters or prioritization schemes described above, including indication type, UL channel type, time domain parameters, TRP, and/or TCI state ID, to select the single TCI state for transmitting both the first UL communication and the second UL communication. In some aspects, the transmitting the first UL communication and the second UL communication may be performed using different time domain and/or different frequency domain resources for each configuration. For example, the UE may use FDM or TDM to transmit the first UL communication and the second UL communication using the same TCI state. In some aspects, by selecting the single TCI state for both UL channels associated with the UL communications, the TCI state for a UL channel may be reset or updated.

In another aspect, instead of transmitting the first UL communication at block 830, the method 800 may comprise refraining from transmitting either of the first UL communication or the second UL communication based on the first UL communication colliding with the second UL communication. In this regard, the UE may treat as an error case a collision of UL communications that cannot be simultaneously transmitted in an mTRP communication scenario.

The method 800 may include one or more steps, actions, or other aspects illustrated in FIG. 5 and described above.

### Exemplary Aspects of the Disclosure

Aspect 1. A method of wireless communication performed by a user equipment (UE), the method comprising: receiving a first indication scheduling a first uplink (UL) communication associated with a first transmission configuration indicator (TCI) state and a first transmission reception point (TRP); receiving a second indication scheduling a second UL communication associated with a second TCI state and a second TRP, wherein the second UL communication is scheduled to at least partially overlap in time with the first UL communication, and wherein the first UL communication and the second UL communication are scheduled for at least one of a same component carrier (CC) or a same frequency band; and transmitting, based on a multi-TRP (mTRP) UL prioritization configuration, the first UL communication.

Aspect 2. The method of aspect 1, wherein: the first UL communication is associated with a first UL channel type; the second UL communication is associated with at second UL channel type different from the first UL channel type; and the mTRP UL prioritization configuration indicates that the first UL channel type has a higher priority than the second UL channel type.

Aspect 3. The method of aspect 2, wherein: the first UL communication comprises first information having a first information type; and the mTRP UL prioritization indicates that the first UL communication has a higher priority than the second UL communication based on the first UL channel type and the first information type.

Aspect 4. The method of any of aspects 1-3, wherein: the mTRP UL prioritization configuration indicates that the first TRP has a higher priority than the second TRP.

Aspect 5. The method of aspect 4, wherein: the first TRP is associated with at least one of a first control resource set (CORESET) pool index or the first TCI state; the second TRP is associated with at least one of a second CORESET pool index or the second TCI state; and the mTRP UL prioritization configuration indicates that at least one of the first CORESET pool index or the first TCI state has a higher priority than at least one of the second CORESET pool index or the second TCI state.

Aspect 6. The method of any of aspects 1-5, wherein: the first indication scheduling the first UL communication comprises downlink control information (DCI) including a scheduling grant for the first UL communication; the second indication scheduling the second UL communication comprises at least one of a radio resource control (RRC) message or a media access control control element (MAC-CE) scheduling the second UL communication; and the mTRP UL prioritization configuration indicates that the first indication has a higher priority than the second indication based on the first indication comprising the scheduling grant and the second indication comprising the at least one of the RRC message or the MAC-CE.

Aspect 7. The method of any of aspects 1-6, wherein: the first UL communication is associated with a first time domain allocation; the second UL communication is associated with a second time domain allocation; and the mTRP UL prioritization configuration indicates that the first time domain allocation has a higher priority than the second time domain allocation.

Aspect 8. The method of any of aspects 1-7, wherein: the transmitting the first UL communication comprises transmitting the first UL communication to the first TRP; and the method further comprises: transmitting, simultaneously with the first UL communication and based on the first TCI state, the second UL communication to the second TRP.

Aspect 9. The method of aspect 8, further comprising selecting the first TCI state for the first UL communication and the second UL communication based on at least one of: a UL channel type associated with the first UL communication; a CORESET pool index associated with the first UL communication; or an indication type associated with the first UL communication. Information and signals may be represented using any of a variety of different technologies and techniques.

Aspect 10. A user equipment (UE) comprising: a memory device; a transceiver; and a processor in communication with the memory device and the transceiver, wherein the UE is configured to perform the actions of any of aspects 1-9.

Aspect 11. A non-transitory, computer-readable medium having program code recorded thereon, wherein the program code comprises instructions executable by a processor of a user equipment (UE) to cause the UE to perform the actions of any of aspects 1-9.

Aspect 10. A user equipment (UE) comprising means for performing the actions of any of aspects 1-9.

For example, data, instructions, commands, information, signals, bits, symbols, and chips that may be referenced throughout the above description may be represented by voltages, currents, electromagnetic waves, magnetic fields or particles, optical fields or particles, or any combination thereof.

Aspect The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some examples thereof, but rather, should be fully commensurate with that of the claims appended hereafter and their functional equivalents.

1. A method of wireless communication performed by a user equipment (UE), the method comprising:
receiving a first indication scheduling a first uplink (UL) communication associated with a first transmission configuration indicator (TCI) state and a first transmission reception point (TRP);
receiving a second indication scheduling a second UL communication associated with a second TCI state and a second TRP, wherein the second UL communication is scheduled to at least partially overlap in time with the first UL communication, and wherein the first UL communication and the second UL communication are scheduled for at least one of a same component carrier (CC) or a same frequency band; and
transmitting, based on a multi-TRP (mTRP) UL prioritization configuration, the first UL communication.

2. The method of claim 1, wherein:
the first UL communication is associated with a first UL channel type;
the second UL communication is associated with at second UL channel type different from the first UL channel type; and
the mTRP UL prioritization configuration indicates that the first UL channel type has a higher priority than the second UL channel type.

3. The method of claim 2, wherein:
the first UL communication comprises first information having a first information type; and
the mTRP UL prioritization indicates that the first UL communication has a higher priority than the second UL communication based on the first UL channel type and the first information type.

4. The method of claim 1, wherein:
the mTRP UL prioritization configuration indicates that the first TRP has a higher priority than the second TRP.

5. The method of claim 4, wherein:
the first TRP is associated with at least one of a first control resource set (CORESET) pool index or the first TCI state;
the second TRP is associated with at least one of a second CORESET pool index or the second TCI state; and
the mTRP UL prioritization configuration indicates that at least one of the first CORESET pool index or the first TCI state has a higher priority than at least one of the second CORESET pool index or the second TCI state.

6. The method of claim 1, wherein:
the first indication scheduling the first UL communication comprises downlink control information (DCI) including a scheduling grant for the first UL communication;
the second indication scheduling the second UL communication comprises at least one of a radio resource control (RRC) message or a media access control control element (MAC-CE) scheduling the second UL communication; and
the mTRP UL prioritization configuration indicates that the first indication has a higher priority than the second indication based on the first indication comprising the scheduling grant and the second indication comprising the at least one of the RRC message or the MAC-CE.

7. The method of claim 1, wherein:
the first UL communication is associated with a first time domain allocation;
the second UL communication is associated with a second time domain allocation; and
the mTRP UL prioritization configuration indicates that the first time domain allocation has a higher priority than the second time domain allocation.

8. The method of claim 1, wherein:
the transmitting the first UL communication comprises transmitting the first UL communication to the first TRP; and
the method further comprises:
transmitting, simultaneously with the first UL communication and based on the first TCI state, the second UL communication to the second TRP.

9. The method of claim 8, further comprising selecting the first TCI state for the first UL communication and the second UL communication based on at least one of:
a UL channel type associated with the first UL communication;
a CORESET pool index associated with the first UL communication; or
an indication type associated with the first UL communication.

10. A user equipment (UE) comprising:
a memory device;
a transceiver; and
a processor in communication with the memory device and the transceiver, wherein the UE is configured to:
receive a first indication scheduling a first uplink (UL) communication associated with a first transmission configuration indicator (TCI) state and a first transmission reception point (TRP);
receive a second indication scheduling a second UL communication associated with a second TCI state and a second TRP, wherein the second UL communication is scheduled to at least partially overlap in time with the first UL communication, and wherein the first UL communication and the second UL communication are scheduled for at least one of a same component carrier (CC) or a same frequency band; and
transmit, based on a multi-TRP (mTRP) UL prioritization configuration, the first UL communication.

11. The UE of claim 10, wherein:
the first UL communication is associated with a first UL channel type;
the second UL communication is associated with at second UL channel type different from the first UL channel type; and
the mTRP UL prioritization configuration indicates that the first UL channel type has a higher priority than the second UL channel type.

12. The UE of claim 11, wherein:
the first UL communication comprises first information having a first information type; and
the mTRP UL prioritization indicates that the first UL communication has a higher priority than the second UL communication based on the first UL channel type and the first information type.

13. The UE of claim 10, wherein:
the mTRP UL prioritization configuration indicates that the first TRP has a higher priority than the second TRP.

14. The UE of claim 13, wherein:
the first TRP is associated with at least one of a first control resource set (CORESET) pool index or the first TCI state;
the second TRP is associated with at least one of a second CORESET pool index or the second TCI state; and
the mTRP UL prioritization configuration indicates that at least one of the first CORESET pool index or the first TCI state has a higher priority than at least one of the second CORESET pool index or the second TCI state.

15. The UE of claim 10, wherein:
the first indication scheduling the first UL communication comprises downlink control information (DCI) including a scheduling grant for the first UL communication;
the second indication scheduling the second UL communication comprises at least one of a radio resource control (RRC) message or a media access control control element (MAC-CE) scheduling the second UL communication; and
the mTRP UL prioritization configuration indicates that the first indication has a higher priority than the second indication based on the first indication comprising the scheduling grant and the second indication comprising the at least one of the RRC message or the MAC-CE.

16. The UE of claim 10, wherein:
the first UL communication is associated with a first time domain allocation;
the second UL communication is associated with a second time domain allocation; and
the mTRP UL prioritization configuration indicates that the first time domain allocation has a higher priority than the second time domain allocation.

17. The UE of claim 10, wherein:
the UE is configured to transmit the first UL communication to the first TRP; and
the UE is further configured to:
transmit, simultaneously with the first UL communication and based on the first TCI state, the second UL communication to the second TRP.

18. The UE of claim 17, wherein the UE is further configured to select the first TCI state for the first UL communication and the second UL communication based on at least one of:
a UL channel type associated with the first UL communication;
a CORESET pool index associated with the first UL communication; or
an indication type associated with the first UL communication.

19. A non-transitory, computer-readable medium having program code recorded thereon, wherein the program code comprises instructions executable by a processor of a user equipment (UE) to cause the UE to:
receive a first indication scheduling a first uplink (UL) communication associated with a first transmission configuration indicator (TCI) state and a first transmission reception point (TRP);
receive a second indication scheduling a second UL communication associated with a second TCI state and a second TRP, wherein the second UL communication is scheduled to at least partially overlap in time with the first UL communication, and wherein the first UL communication and the second UL communication are scheduled for at least one of a same component carrier (CC) or a same frequency band; and
transmit, based on a multi-TRP (mTRP) UL prioritization configuration, the first UL communication.

20. The non-transitory, computer-readable medium of claim 19, wherein:
the first UL communication is associated with a first UL channel type;
the second UL communication is associated with at second UL channel type different from the first UL channel type; and
the mTRP UL prioritization configuration indicates that the first UL channel type has a higher priority than the second UL channel type.

21. The non-transitory, computer-readable medium of claim 20, wherein:
the first UL communication comprises first information having a first information type; and
the mTRP UL prioritization indicates that the first UL communication has a higher priority than the second UL communication based on the first UL channel type and the first information type.

22. The non-transitory, computer-readable medium of claim 19, wherein:
the mTRP UL prioritization configuration indicates that the first TRP has a higher priority than the second TRP.

23. The non-transitory, computer-readable medium of claim 22, wherein:
the first TRP is associated with at least one of a first control resource set (CORESET) pool index or the first TCI state;
the second TRP is associated with at least one of a second CORESET pool index or the second TCI state; and
the mTRP UL prioritization configuration indicates that at least one of the first CORESET pool index or the first TCI state has a higher priority than at least one of the second CORESET pool index or the second TCI state.

24. The non-transitory, computer-readable medium of claim 19, wherein:
the first indication scheduling the first UL communication comprises downlink control information (DCI) including a scheduling grant for the first UL communication;
the second indication scheduling the second UL communication comprises at least one of a radio resource control (RRC) message or a media access control control element (MAC-CE) scheduling the second UL communication; and
the mTRP UL prioritization configuration indicates that the first indication has a higher priority than the second indication based on the first indication comprising the scheduling grant and the second indication comprising the at least one of the RRC message or the MAC-CE.

25. The non-transitory, computer-readable medium of claim 19, wherein:
the first UL communication is associated with a first time domain allocation;
the second UL communication is associated with a second time domain allocation; and
the mTRP UL prioritization configuration indicates that the first time domain allocation has a higher priority than the second time domain allocation.

26. The non-transitory, computer-readable medium of claim 19, wherein:
the program code comprises instructions to cause the UE to transmit the first UL communication to the first TRP; and
the program code further comprises instructions to cause the UE to:
transmit, simultaneously with the first UL communication and based on the first TCI state, the second UL communication to the second TRP.

27. The non-transitory, computer-readable medium of claim 26, wherein the program code further comprises instructions to cause the UE to select the first TCI state for the first UL communication and the second UL communication based on at least one of:
a UL channel type associated with the first UL communication;
a CORESET pool index associated with the first UL communication; or
an indication type associated with the first UL communication.

28. A user equipment (UE), comprising:
means for receiving a first indication scheduling a first uplink (UL) communication associated with a first transmission configuration indicator (TCI) state and a first transmission reception point (TRP);
means for receiving a second indication scheduling a second UL communication associated with a second TCI state and a second TRP, wherein the second UL communication is scheduled to at least partially overlap in time with the first UL communication, and wherein the first UL communication and the second UL communication are scheduled for at least one of a same component carrier (CC) or a same frequency band; and
means for transmitting, based on a multi-TRP (mTRP) UL prioritization configuration, the first UL communication.

29. The UE of claim 28, wherein:
the first UL communication is associated with a first UL channel type;
the second UL communication is associated with at second UL channel type different from the first UL channel type; and
the mTRP UL prioritization configuration indicates that the first UL channel type has a higher priority than the second UL channel type.

30. The UE of claim 28, wherein:
the first indication scheduling the first UL communication comprises downlink control information (DCI) including a scheduling grant for the first UL communication;
the second indication scheduling the second UL communication comprises at least one of a radio resource control (RRC) message or a media access control control element (MAC-CE) scheduling the second UL communication; and
the mTRP UL prioritization configuration indicates that the first indication has a higher priority than the second indication based on the first indication comprising the scheduling grant and the second indication comprising the at least one of the RRC message or the MAC-CE.
